(19) United States
(12) Patent Application Publication
(10) Pub. No.: US 2007/0060045 A1
(43) Pub. Date: Mar. 15, 2007

(54) System and technique for situational awareness

(76) Inventor: Frank R. Prautzsch, Acton, MA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/345,972

(22) Filed: Feb. 1, 2006

Related U.S. Application Data
(60) Provisional application No. 60/649,292, filed on Feb. 2, 2005.

(51) Int. Cl. H04H 7/00

(52) U.S. Cl. 455/3.06

(57) ABSTRACT

A situational awareness system includes a first local network having a plurality of digital communication devices, each device capable of gathering information pertinent to an area in proximity of the device and providing information to a control station capable of collaborating the information and provide such information to the devices on the local network; a first regional network having a plurality of local networks, including the first local network, within an area of responsibility, the first regional network having a regional control station capable of collaborating information from the devices and provide said information to devices on the local network; and a central network having a plurality of regional networks including the first regional network, the central network having a central control station capable of collaborating information from the regional control stations and provide the information to devices on a local network.

### CROSS-REFERENCE TO RELATED APPLICATIONS

This application claims priority to provisional application Ser. No. 60/649,292, titled “SYSTEM AND TECHNIQUE FOR SITUATIONAL AWARENESS”, filed Feb. 2, 2005, which is incorporated herein in its entirety.

### STATEMENTS REGARDING FEDERALLY SPONSORED RESEARCH

Not applicable.

### FIELD OF THE INVENTION

This invention relates generally to situational awareness systems and more particularly to a system to provide data and navigational information to users in the field using datacasting and navcasting.

### BACKGROUND OF THE INVENTION

It is common practice to deploy first responders to a remote location in response to an emergency. In recent years, such emergencies have included natural disasters, peace keeping missions, attacks by terrorists and deployments in support of the global war on terrorism. A common problem among first responders and later sustainment forces is to provide accurate and current information to the responder or warrior on the ground at the deployed location. One attempt to provide a more robust solution, is the Global Broadcast Service (GBS) which utilizes popular commercial direct broadcast satellite technology to provide critical information to the warfighter. The GBS system is a space based, high data rate communications link for the asymmetric flow of information from the United States or rear echelon locations to deployed forces. Although a GBS terminal is much smaller than prior systems, the receive terminals for information can still be large as high-volume data is directly fed into 18-inch antennas, and having a cost that is still beyond the ability to outfit many disadvantaged users. First responders and mobile deployed forces must be capable of rapid movement and not be tied down to fixed systems.

It is typical for deployed forces (including first responders) to have a need to locate, track and communicate with individuals on a world-wide basis. Large fixed type systems have been developed for providing position location and communications for military applications. Other specialized systems such as RFID have been developed for identifying, locating and tracking cargo. However, these systems typically have limited range, limited data handling capability and do not provide an integrated solution. These systems also tend to use stand alone protocols that impeded the interoperability and sharing of data and information. There is a need to provide an integrated system to overcome the problems and limitations inherent in a system made up of many ad hoc elements.

### SUMMARY OF THE INVENTION

In accordance with the present invention, a situational awareness system includes a first local network having a plurality of digital communication devices, each device capable of gathering information pertinent to an area in proximity of the device and providing information to a local control station capable of collaborating the information and provide such information to the devices on the local network; a first regional network having a plurality of local networks, including the first local network, within an area of responsibility, the first regional network having a regional control station capable of collaborating information from the local control station and provide said information to devices on the local network; and a central network having a plurality of regional networks including the first regional network, the central network having a central control station capable of collaborating information from the regional control stations and provide the information to devices on a local network.

With such an arrangement, Global Positioning System (GPS) data, Enhanced Position Locating Reporting System (EPLRS) data, identification and data communications with commercial satellites and military satellites can be distributed and shared to individuals worldwide having a need to know yet providing security and information assurance.

In accordance with a further aspect of the present invention, the local network is a digital audio radio satellite system having a plurality of mobile satellite receivers, satellite receivers with local GPS, satellite receivers with local GPS location broadcast, satellite receivers with satcom or line-of-site radios capable of communication with each other through a satellite or other networks. Furthermore, the information includes global position system (GPS) location, timing, or reference information, as well as data, video, navigational and audio information. With such an arrangement, current needed information can be provided to the deployed forces in a real time manner, as well as to military forces and first responders on the move to include coverage in the air, on land, on the surface of the ocean, and to subsurface platforms using towed or tethered arrays. Furthermore, information can be communicated to the final destination without operator intervention and with multiple redundant links, the effects of jamming and cyber attacks are reduced while establishing a fully mobile network in an ad hoc manner yet maintaining security and information assurance. In addition, the U.S. satellite digital audio radio system employs a series of 800 radio repeaters for which this application supports use of such assets both in bandwidth and infrastructure in support of Homeland Security and Homeland Defense.

In accordance with a further aspect of the present invention, a situational awareness system includes a plurality of local communication devices capable of providing device dependent information to a regional information center, the regional information center capable of integrating and collaborating the device dependent information to provide global situational awareness information; and a digital audio radio satellite system to commute the global situational awareness information to mobile transceivers and to commute the navigation augmentation signals to mobile transceivers utilized for improved GPS performance.

With such an arrangement, the advantages of Digital Audio Radio Satellite (SDARS) broadcast coverage and capability, and Regional and/or Mobile Satellite Services (RSS/MSS) or MUOS for the purposes of DataCasting are exploited. The additional application of spread spectrum satellite RF ID tagging introduces the integration of information request, geolocation and common operational picture, as well as high data rate dissemination to mobile platforms. Capabilities inherent to using these systems allow for potential support to both the warfighter and the consumer for mobile situational awareness, C2-on-the-Move, navigational augmentation, air traffic management, intelligent transport, special operations missions, GPS augmentation, asset management, and remote C2. Such a technique, employs the marriage of “information pull” using RSS/FSS to a common regional or global information management hub, and “information push” using DARS for the broadcast of data vice audio to mobile receivers and information pull would typically be at rates of 2.4 Kbps to 64 Kbps and information push would typically be at rates of up to 40-128 Kbps.

### BRIEF DESCRIPTION OF THE DRAWINGS

The foregoing features of this invention, as well as the invention itself, may be more fully understood from the following description of the drawings in which:

FIG. 1 is a pictorial diagram of a situational awareness system according to the invention;

FIG. 1A is a pictorial diagram of a more detailed embodiment of a situational awareness system according to the invention;

FIG. 1B is a pictorial diagram of an alternative embodiment of a situational awareness system according to the invention;

FIG. 1C is a pictorial diagram of an alternative embodiment of a situational awareness system according to the invention;

FIG. 1D is a pictorial diagram of an alternative embodiment of a situational awareness system according to the invention;

FIG. 1E is a pictorial diagram of an alternative embodiment of a situational awareness system according to the invention;

FIG. 2A is block diagram of a receive system using S-band for a situational awareness system according to the invention;

FIG. 2B is block diagram of a receive system using L-band for a situational awareness system according to the invention;

FIG. 2C is block diagram of an alternative embodiment of a receive system using L-band for a situational awareness system according to the invention;

FIG. 3 is a pictorial diagram of a situational awareness system using datacasting to distribute information among various devices among various networks according to the invention;

FIG. 3A is a pictorial diagram of a compact mobile terminal for obtaining information according to the invention;

FIG. 3B is a pictorial diagram of a situational awareness system for distributing information among various mobile devices throughout a satellite network with terrestrial repeaters according to the invention;

FIG. 4 is a pictorial diagram of spectrum usage within existing x-band frequency allocation to provide information according to the invention;

FIG. 5 is a pictorial diagram of spectrum usage within existing L-band frequency allocation to provide information according to the invention;

FIG. 6 is a pictorial and block diagram of a compact mobile terminal for obtaining and displaying information according to the invention;

FIG. 6A is a pictorial diagram showing satellite weather information within a display of a mobile terminal according to the invention;

FIG. 7 is a pictorial and block diagram of a real-time alerting and data delivery process according to the invention;

FIG. 8 is a pictorial and block diagram of information flow process according to the invention; and

FIG. 9 is a pictorial diagram of a convoy in route with a real-time alerting and data delivery process according to the invention.

### DETAILED DESCRIPTION OF THE INVENTION

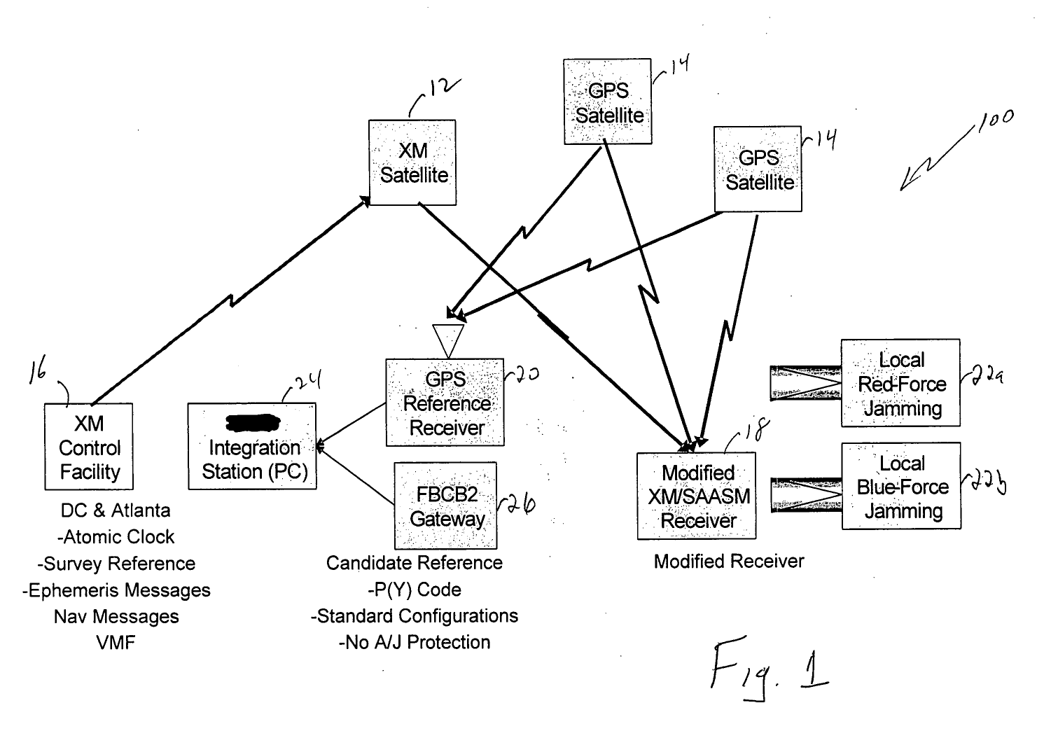

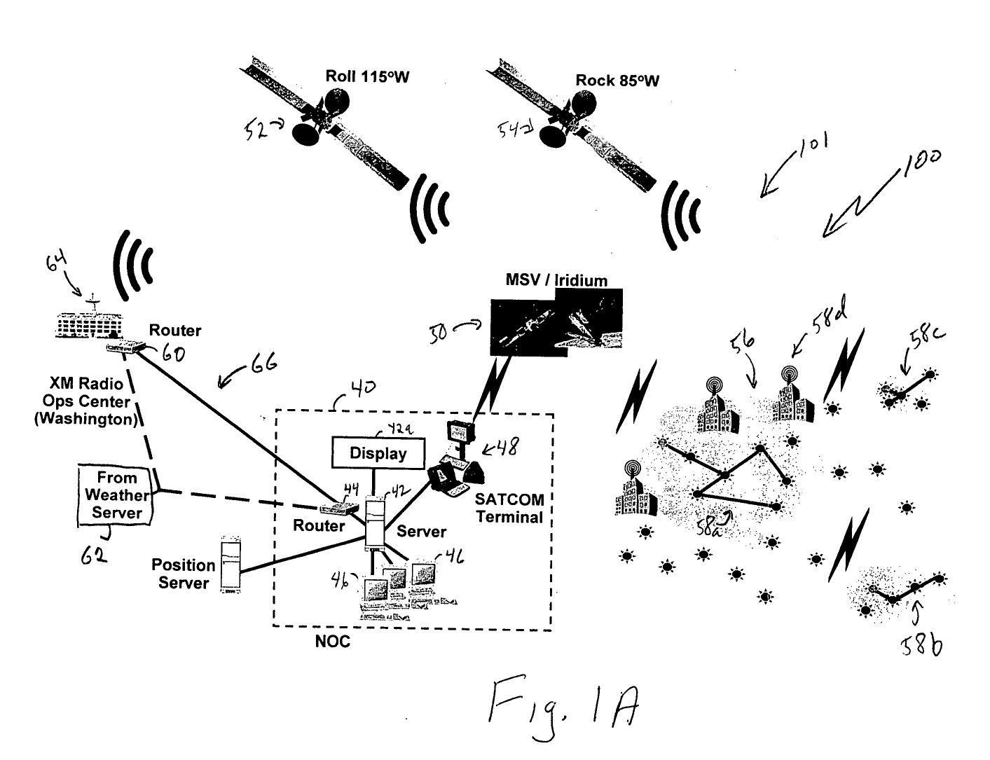

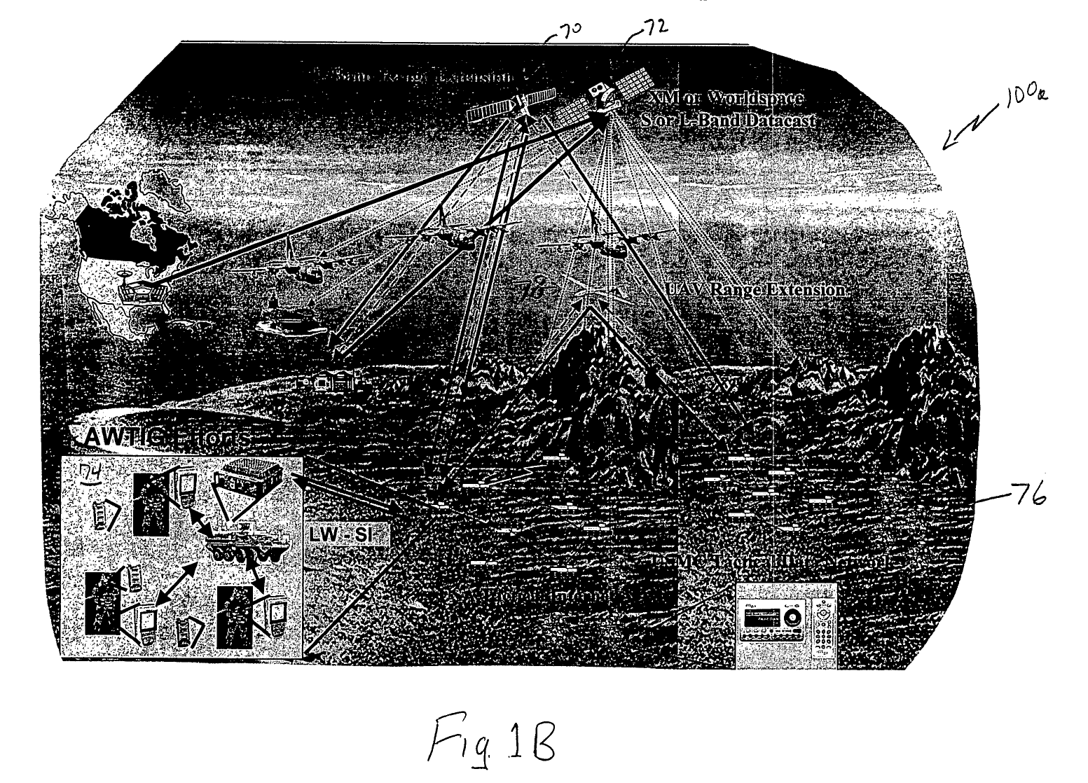

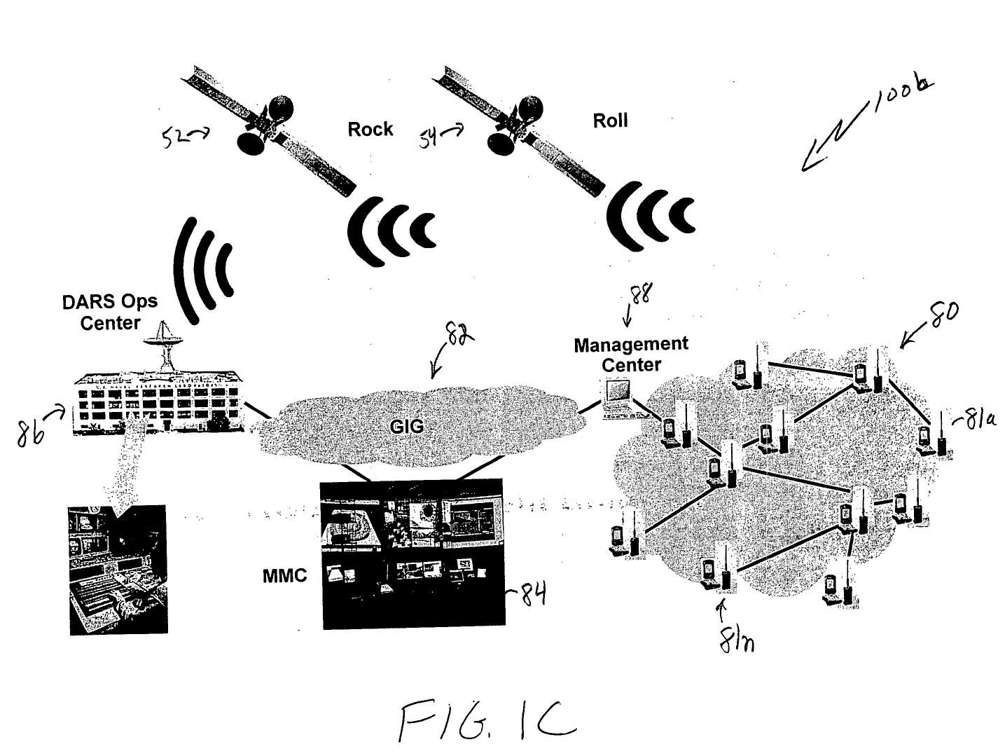

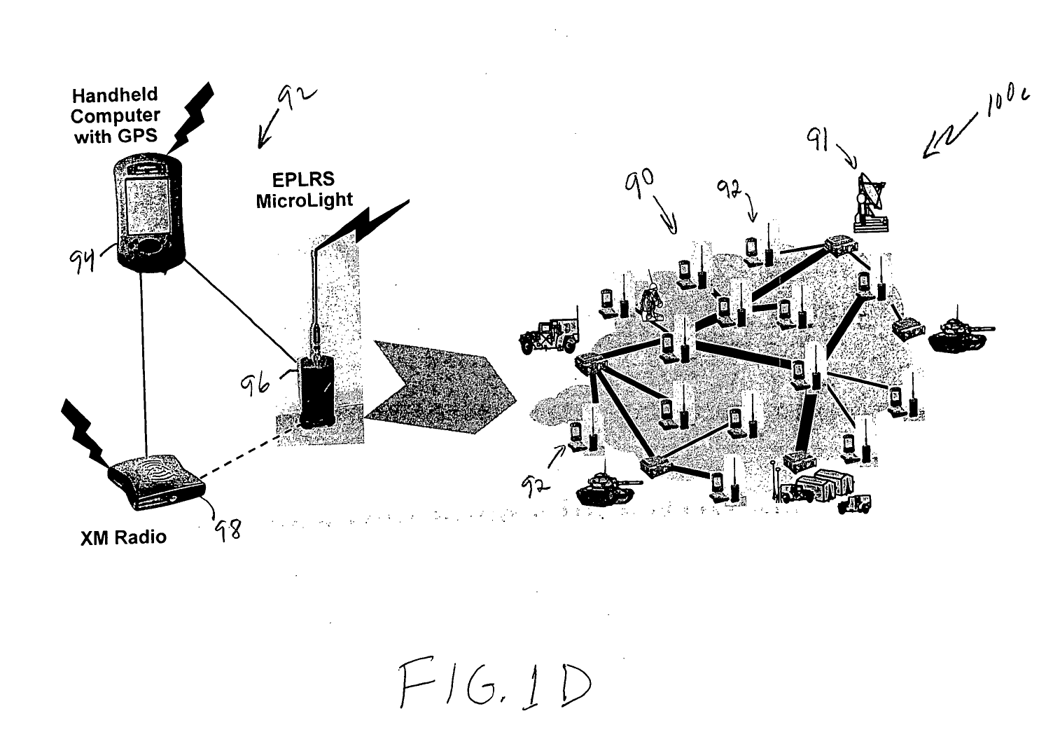

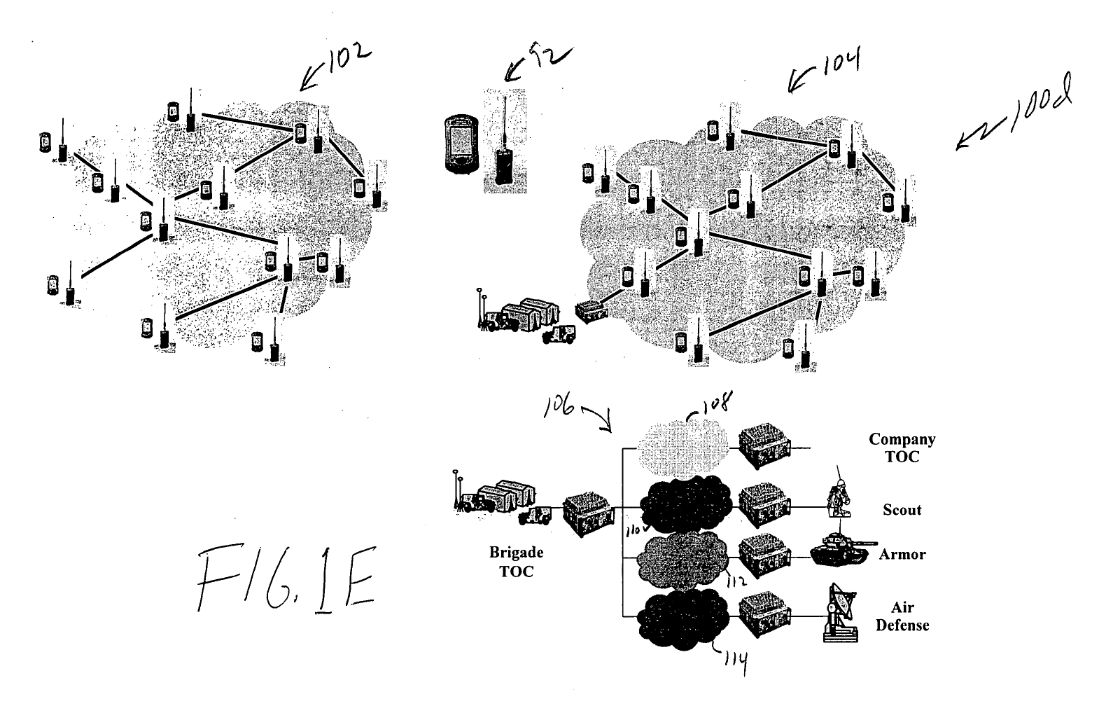

Referring now to FIG. 1, a pictorial diagram is shown of a situational awareness system 100 (sometimes referred to as a mobile broadcast system 100) according to the invention including a communication satellite 12 and GPS satellites 14. The communication satellite 12 operates in a known manner wherein signals are received from a ground station 16 and retransmitted to a receiver 18 as is known in the art. Also shown is a GPS receiver 20 for receiving GPS signals from the GPS satellites 14 which are part of the Global Positioning System and operating in a known manner provides location data to the receiver 20. It should be noted that receiver 18 as described further hereinafter also includes a GPS receiver (not shown) capable receiving GPS signals from the GPS satellites 14. Also depicted are jamming devices 22a and 22b which may be used to provide interference to the situational awareness system 100. An integration station 24 is connected to the GPS receiver 20 and a gateway 26. The control facility 16 includes a control processor (not shown) having all of the elements required to do computer processing including computer software instructions, as to be described in more detail hereinafter, that controls the manner in which the situational awareness system 100 operates. The latter provides a system and technique for datacasting and navcasting. Datacasting is the process of taking computer data stored in large files and multimedia presentations, packaging them, and sending them over the air for reception at a computer. Navcasting is the process of taking navigational data stored in large files, packaging them, and sending them over the air for reception at a computer.

With such an arrangement, the situational awareness system 100 allows collection and dissemination of information to the mobile user. As to be described in more detail, such an arrangement provides a flexible configuration that can use either commercial satellites or military satellites with user equipment having minimum costs. The user equipment (i.e. digital communication device 0 is configured in such a manner that it can be easily moved to accommodate the environment and provides information about a particular user such as identification, location, status, needs as well as allow the user to request specific information, monitor and collect data continuously and to provide supplemental information for navigation. Information such as selected low-data rate imagery or graphics can be provided for force tracking, battlefield paging, connectivity to airframes, dissemination of intelligence, maneuver, logistics and command knowledge and selected C2 on the move requirements. It should also be appreciated that such a system offers the capability to coordinate information rapidly between government agencies and services in a mobile or dynamic environment. Additionally, datacasting can be used to inform the population of emergency events or circumstances beyond the capabilities of local broadcast, cable or direct-to-home broadcasts.

Referring now to FIG. 1A, a pictorial diagram is shown of a more detailed embodiment of a situational awareness system 100 according to the invention including a network operation center 40 having a server 42 with a display 42a, a router 44 for connecting to other network devices such as router 60 or weather server 62. The server 42 is also connected to a local area network (LAN) having a plurality of computers 46 also connected thereto. Also connected to the LAN is a satellite terminal 48 which is capable of connecting to a satellite 50 to connect the satellite terminal 48 to the satellite network associated with satellite 50. The situational awareness system 100 also includes a satellite 52 and a satellite 54 which communicates with satellite terminal 64 which is also connected to router 60. A regional network 56 is also included in the situational awareness system 100 wherein the regional network 56 includes a plurality of local area networks including local area networks 58a, 58b and 58c. The local area networks are connected using the satellite network provided by satellites 52 and 54.

It should now be appreciated that the situational awareness system 100 in this embodiment is a mobile space broadcast system having a first local network such as local area network 58a having a plurality of digital communication devices, each device capable of receiving information pertinent to an area either by unit type, geographical location, hierarchy, or precedence in proximity of the devise and also provide such information to the devices on the local network as an accelerated update compared to conventional means.

The situational awareness system 100 also includes a first global and/or regional mobile broadcast network, such as regional network 56, having a plurality of local networks which may have entertainment broadcast services such as local network 58d, and includes the first local network 58a, within an area of responsibility, the first regional network having a regional control station capable of collaborating information from the local control station and provide said information to devices on the local, regional, or global broadcast network. Completing this embodiment of the situational awareness system 100 is a central network 101 having a plurality of regional networks including the first regional network 56 and regional network 66, the central network having a central control station, here network operation center 40, capable of collaborating information from the regional control stations and provide the information to devices on a local network or using local, regional, or global satellite mobile broadcast over entertainment channels.

In this embodiment, the local network 58a is a digital audio radio satellite system having a plurality of mobile satellite receivers, having satellite receivers with local GPS, having satellite receivers with local GPS location broadcast, having satellite receivers with satcom or line-of-site radios, capable of communication with each other through a satellite or via the regional network 56. The information being communicated includes global position system (GPS) location, timing, or reference information sent via a common reference hub as an GPS augmentation signal to said entertainment receivers as well as data, video, navigational and audio information. The GPS augmentation signal is reintroduced to standard GPS users getting less accurate or survivable data from the current GPS constellation with this augmentation. Typically, the digital communication device is disposed within a moving vehicle or robot and the moving vehicles can include an aircraft, unmanned aerial vehicle or helicopter as well as a tank, ship, or submarine.

In this example, the local network 58b is a terrestrial repeater network having a plurality of transceivers capable of communicating with each other using geographically dispersed repeaters. Alternatively, the local network 58b may include a combination of a terrestrial repeater system and a digital audio radio satellite system.

It should also be appreciated that all of the collaborated information is communicated to the regional control and net management system or alternatively selected portions of the collaborated information can be communicated to the regional control and net management system.

Depending on topography, the regional networks are connected using one of the techniques including land lines, radio links and satellite links to provide regional collaborated data to the central control system. The central control system can broad cast the collaborated data to any communication device who has requested the collaborated data or receives data in a scheduled broadcast.

Furthermore, National 911 call centers are linked into the NIEC and/or Regional Centers to monitor 911 call traffic and analyze for terror or disaster events requiring state or national involvement. The system may then broadcast situational awareness information over the network using Mobility Enhanced Situational Awareness (MESA) and/or standard communications services to first responders after receiving government approval at network operation center. As described above, the latter leverages the advantages of using mobile broadband with the XM repeater architecture to provide management operations for large-scale disasters or multiple locality/state responses in response to terrorist events, natural disasters, disease control, or other catastrophic events. Furthermore, the system 100 provides the ability to rapidly recognize large scale emergencies in localized areas as they occur by networking the population and then providing tailored responses to key officials, first responders, or the general population as may be needed.

Referring now to FIG. 1B, a pictorial diagram is shown of still another embodiment of a situational awareness system 100a according to the invention which is similar to situational awareness system 100 but here includes satellites 70 and 72 operating in L-band and S-band. In addition, a tactical network 74 including digital devices located on moving tanks is included as well as a tactical network 76 including digital devices carried on the backs of soldiers. In this embodiment, a UAV 78 is provided to provide radio relay over the mountain range to connect the network among the moving tanks.

Referring now to FIG. 1C, a pictorial diagram is shown of still another embodiment of a situational awareness system 100b according to the invention including the satellite 52 and the satellite 54 which communicates with satellite terminal 86 which is also connected to a global information grid (GIG) 82. A network 80 is also included in the situational awareness system 100b wherein the network 80 includes a plurality of digital devices including devices 81a and 81n. The digital devices 81a -81n are connected using the satellite network provided by satellites 52 and 54. The network 80 is also connected to a management center 88 which is also connected to the GIG 82. A MMC 84 is also connected to the GIG 82 to provide command and control information.

Referring now to FIG. 1D, a pictorial diagram is shown of still another embodiment of a situational awareness system 100c according to the invention including a network 90 having a plurality digital devices 92 and a plurality of satellite terminals 91. As shown in more detail, the digital device 92 includes an XM radio 98 connected to a handheld computer with GPS 94 or alternatively an EPLRS Microlight 96 connected with the handheld computer with GPS 94. In a preferred embodiment, the digital device 92 is made up of the handheld computer with GPS 94, the EPLRS MicroLight radio 96 and the XM radio 98 to provide dual band capability including UHF and S-band.

Referring now to FIG. 1E, a pictorial diagram is shown of still another embodiment of a situational awareness system 100d according to the invention to include a first local area network 102 having a plurality of digital devices 92 and a second local area network 104 having a plurality of digital devices 92 connected using a satellite system. A regional mobile broadcast network 106 is also included with the regional mobile broadcast network 106 having a local network 108, here to support the company TOC, a local network 110, here to support any scouts, a local network 112, here to support any armor and local network 114, here to support air defense. It should be appreciated with such an arrangement, a plurality of local communication devices, here digital devices 92 are provided capable of providing device dependent information to a regional information center, the regional information center capable of integrating and collaborating the device dependent information to provide global situational awareness information. The digital audio radio satellite system is capable to commute the global situational awareness information to the mobile transceivers, i.e. digital devices 92. It should be noted that using time division multiplexing access allows each radio to participate in multiple nets simultaneous such as a command net, an intel net and an air defense net.

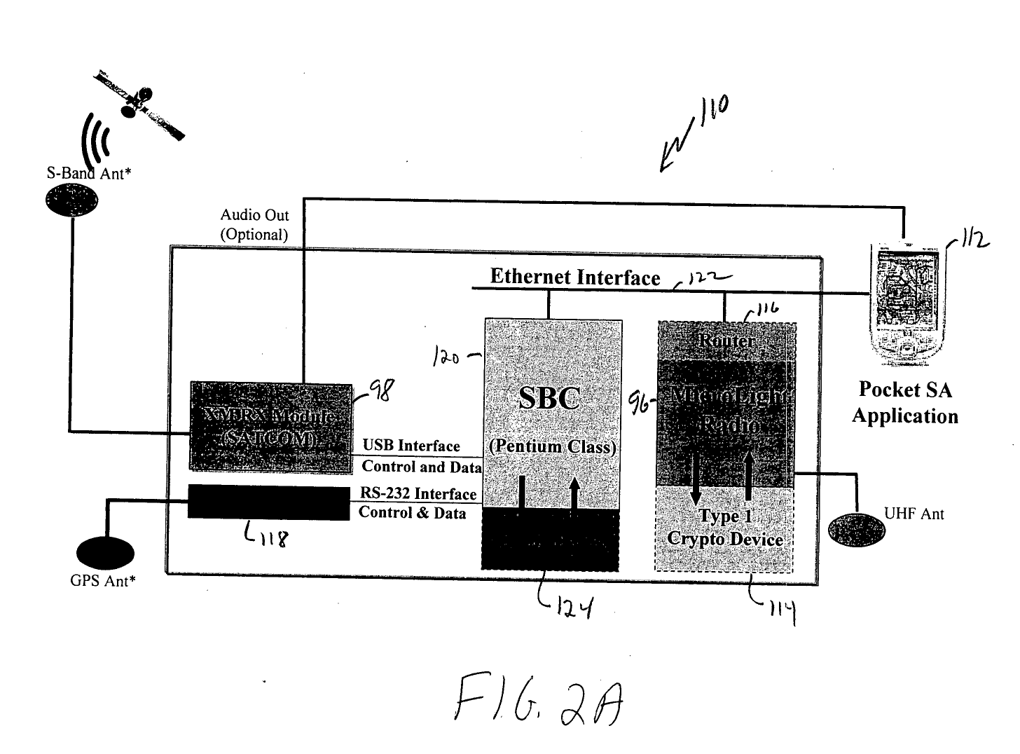

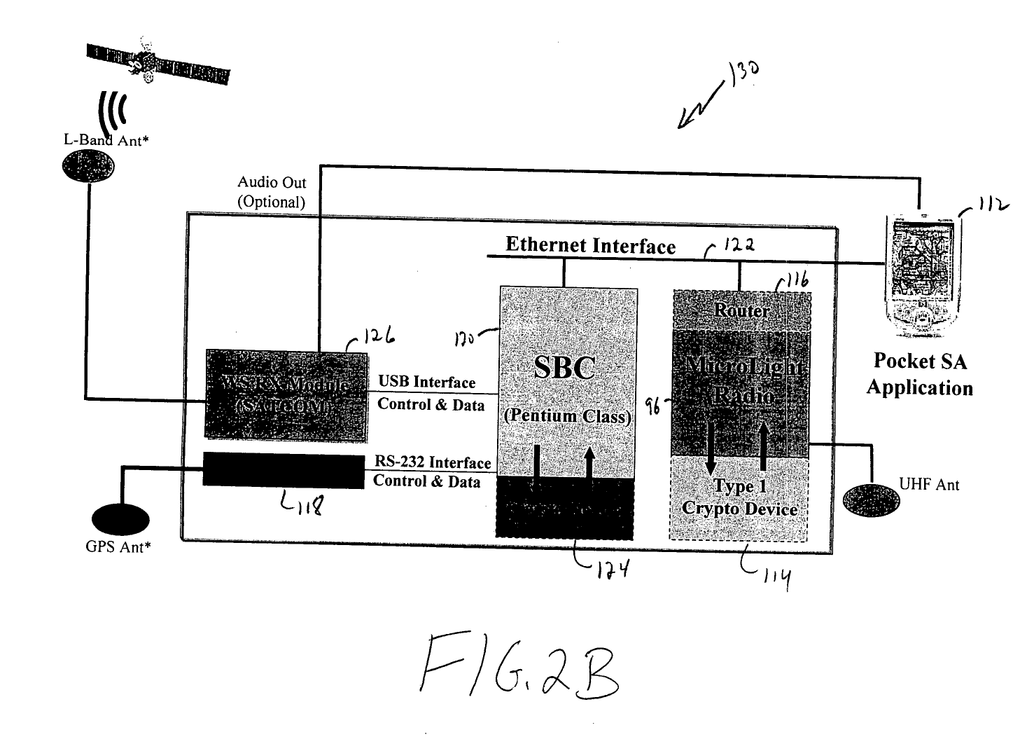

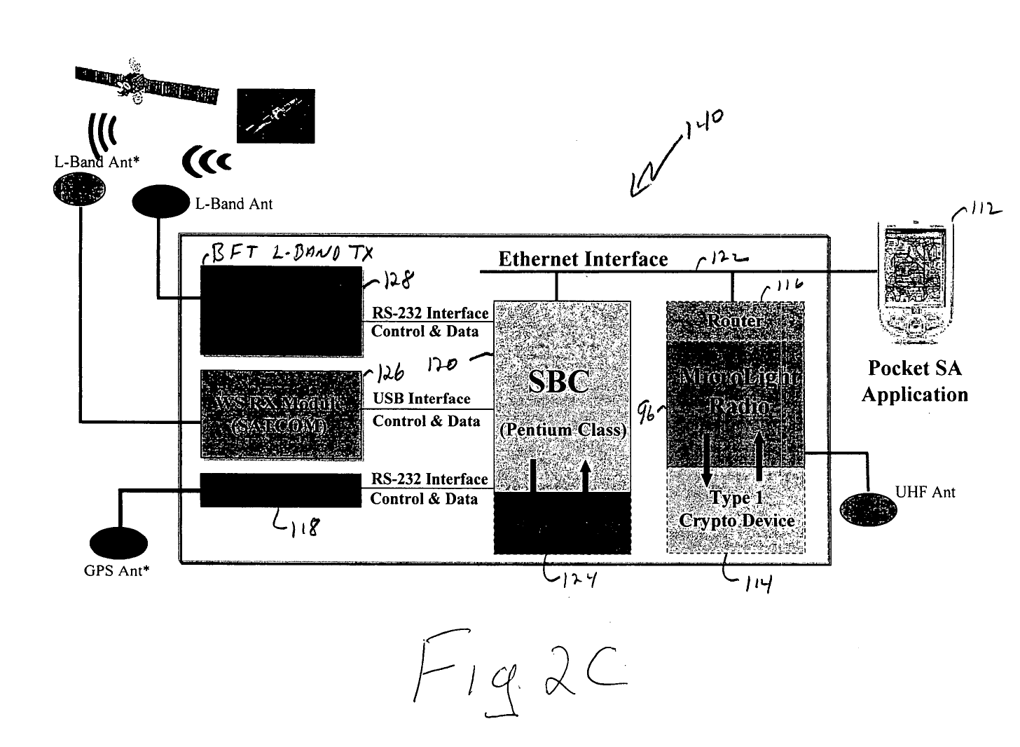

Referring now to FIG. 2A, a block diagram is shown of a digital satellite device 110 as used in the invention. In this embodiment, a personal digital assistant (PDA) 112 is connected to multiband satellite transceiver 114 wherein the satellite transceiver 114 is capable of operating on S-band and UHF. In this embodiment, instead of being an integrated piece of equipment, the UHF capability is provided by a MicroLight radio 96 and the S-band capability is provided by an XM RX module 98. A crypto device 114 is connected to the MicroLight radio 96 to encrypt the transmission. The MicroLight radio is connected to an ethernet interface 122 through a router 116. A GPS receiver 118 provides location data and is connected to a computer 120 through an RS-232 interface. The XM RX module 98 is connected to the computer 120 using an USB interface. The computer 120, radio 96 and PDA 112 are connected using the ethernet interface 122. The computer 120 is encrypted using crypto device 124.

Referring now to FIG. 2B, a block diagram is shown of a digital satellite device 130 as used in the invention. This embodiment is similar to the embodiment of FIG. 2A except that it is intended to operate on L-band instead of S-band. In this embodiment, a personal digital assistant (PDA) 112 is connected to multiband satellite transceiver 114 wherein the satellite transceiver 114 is capable of operating on L-band and UHF. In this embodiment, instead of being an integrated piece of equipment, the UHF capability is provided by a MicroLight radio 96 and the L-band capability is provided by a WS RX module 126. A crypto device 114 is connected to the MicroLight radio 96 to encrypt the transmission. The MicroLight radio is connected to an ethernet interface 122 through a router 116. A GPS receiver 118 provides location data and is connected to a computer 120 through an RS-232 interface. The WS RX module 126 is connected to the computer 120 using an USB interface. The computer 120, radio 96 and PDA 112 are connected using the ethernet interface 122. The computer 120 is encrypted using crypto device 124.

Referring now to FIG. 2C, a block diagram is shown of a digital satellite device 140 as used in the invention. This embodiment is similar to the embodiment of FIG. 2B except that an additional L-band transceiver 128 is included to operate on L-band. In this embodiment, a personal digital assistant (PDA) 112 is connected to multiband satellite transceiver 114 wherein the satellite transceiver 114 is capable of operating on L-band and UHF. In this embodiment, instead of being an integrated piece of equipment, the UHF capability is provided by a MicroLight radio 96 and the L-band capability is provided by a WS RX module 126. A crypto device 114 is connected to the MicroLight radio 96 to encrypt the transmission. The MicroLight radio is connected to an ethernet interface 122 through a router 116. A GPS receiver 118 provides location data and is connected to a computer 120 through an RS-232 interface. The WS RX module 126 is connected to the computer 120 using an USB interface. A BFT L-band transceiver 128 is connected to the computer 120 using an RS-232 interface. The computer 120, radio 96 and PDA 112 are connected using the ethernet interface 122. The computer 120 is encrypted using crypto device 124.

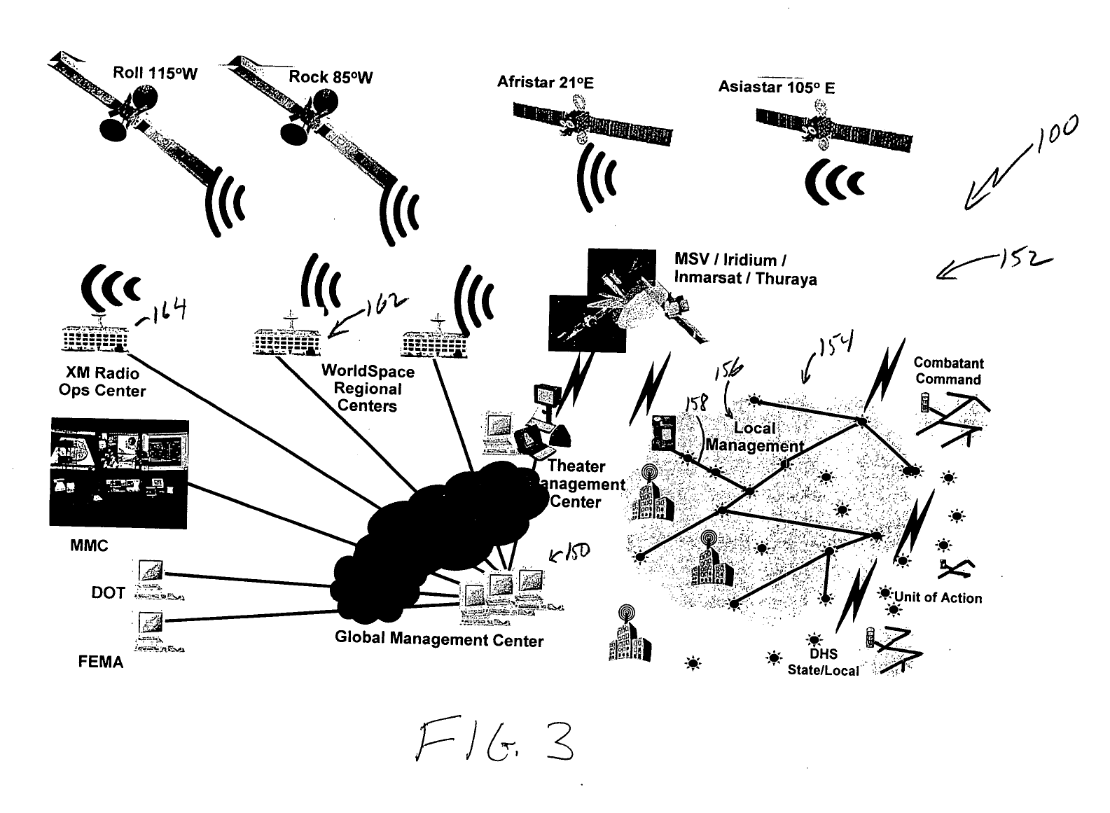

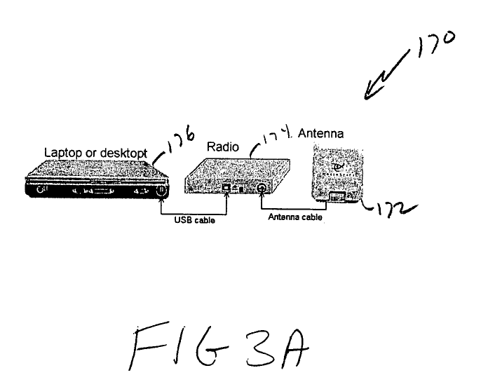

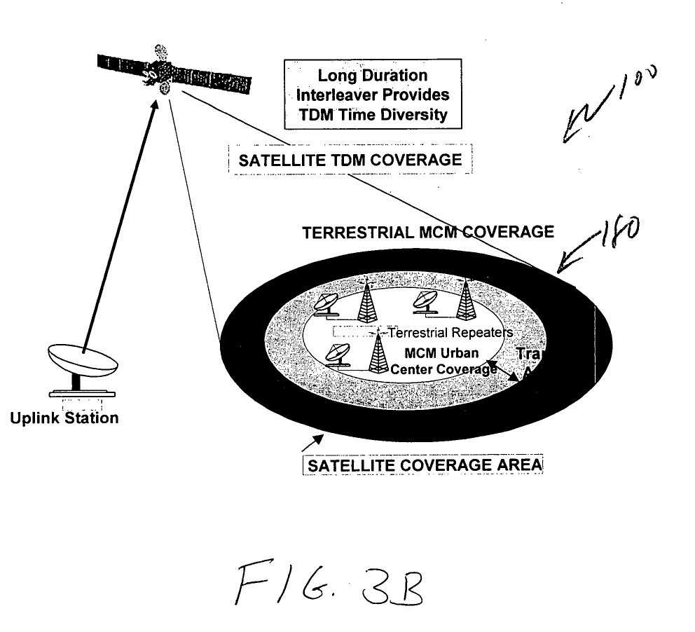

Having referred to various embodiments of the invention, it should now be appreciated referring to FIG. 3, that a full scale system 100 may include a global management center 150 for controlling the global broadcast network 152. The global broadcast network 152 may include regional mobile broadcast networks 154 having regional control stations 162 to control the regional network and collaborate information from the local control stations including local control station 156. The local control station 156 controls a local area network 158. With such an arrangement, the situational awareness system 100 in this embodiment is a mobile space broadcast system having a first local network 158 having a plurality of digital communication devices. Each device is capable of receiving information pertinent to an area either by unit type, geographical location, hierarchy, or precedence in proximity of the device and also provide such information to the devices on the local network as an accelerated update compared to conventional means. The situational awareness system 100 also includes a global and/or regional mobile broadcast network, such as regional network 154, having a plurality of local networks and includes the first local network 158, within an area of responsibility. The regional network 154 has a regional control station 162 capable of collaborating information from the local control station 156 and provide said information to devices on the local, regional, or global broadcast network. Completing this embodiment of the situational awareness system 100 is a central or global network 152 having a plurality of regional networks including the first regional network 154, the central or global network having a central control station, here global management center 150, capable of collaborating information from the regional control stations and provide the information to devices on a local network or using local, regional, or global satellite mobile broadcast.

Referring now to FIG. 3A, a pictorial diagram is shown of another embodiment of a digital device 170. The digital device 170 includes a personal use digital reception radio 174 with a built in DDA. The radio 174 is connected to a laptop computer 176 and an antenna 172. It should be appreciated with such a device, a warning on a secure web page can be entered to include impact coordinates, radius of impact, warning message and time of impact which can then be automatically routed through the satellite such as the XM satellite and message data is received by the XM data radio. The radio routes the data to the laptop computer 176 where the text is displayed in an alert box and graphic alert is displayed on a moving map on the laptop display screen. The laptop computer 176 can be provided by a tablet based type computer, a personal data assistant (PDA), or a notebook computer depending on the user requirements.

Referring now to FIG. 3B, in this example, the system 100 includes a terrestrial repeater network 180 having a plurality of transceivers capable of communicating with each other using geographically dispersed repeaters. Alternatively, the system 100 may include a combination of a terrestrial repeater system and a digital audio radio satellite system.

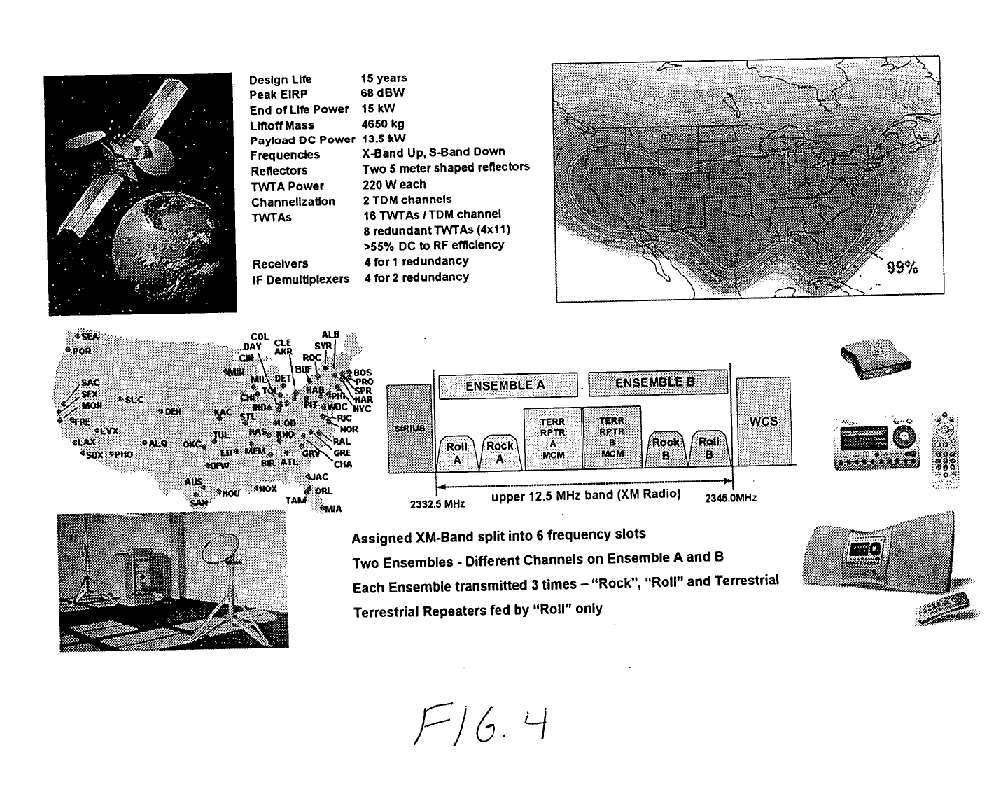

Referring now to FIG. 4, a pictorial diagram is provided showing spectrum usage within existing x-band frequency allocation to provide information according to the invention. In the present example, an assigned XM-band is split into six frequency slots with two ensembles with different channels on the first ensemble (ensemble A) and the second ensemble (ensemble B). Each ensemble is transmitted three times, rock, roll and terrestrial as shown in FIG. 4.

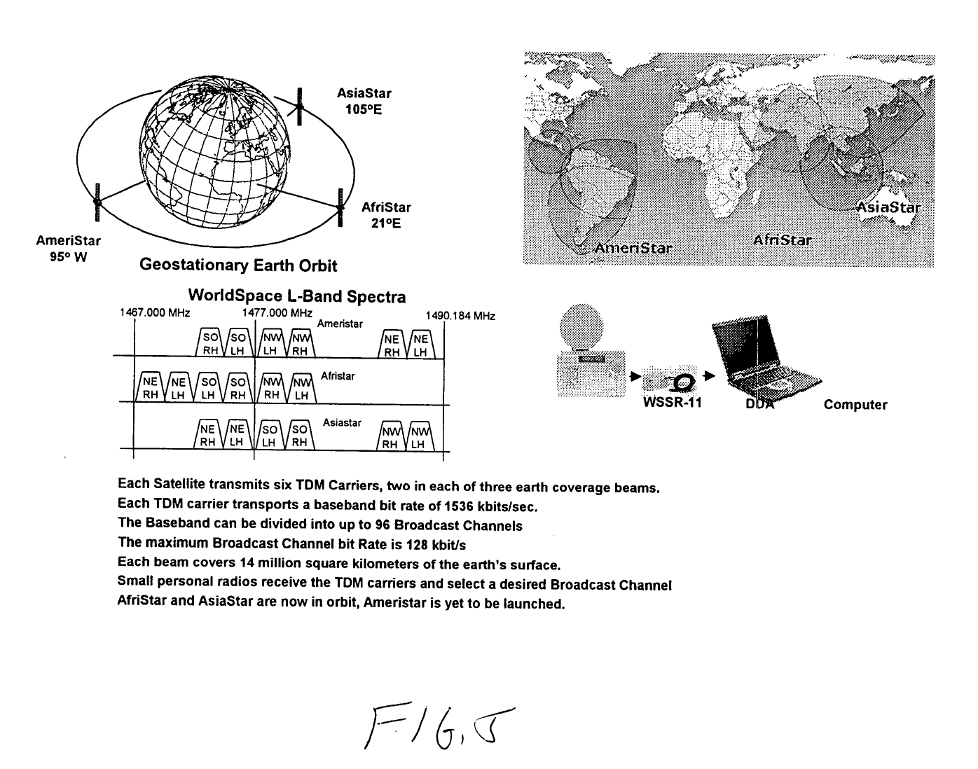

Referring now to FIG. 5, a pictorial diagram is provided showing spectrum usage within existing L-band frequency allocation to provide information according to the invention. Each Satellite transmits six TDM Carriers, two in each of three earth coverage beams. Each TDM carrier transports a baseband bit rate of 1536 kbits/sec. The Baseband can be divided into up to 96 Broadcast Channels. The maximum Broadcast Channel bit Rate is 128 kbit/s. Each beam covers 14 million square kilometers of the earth's surface. Small personal radios receive the TDM carriers and select a desired Broadcast Channel. Note AfriStar and AsiaStar are now in orbit, Ameristar is yet to be launched.

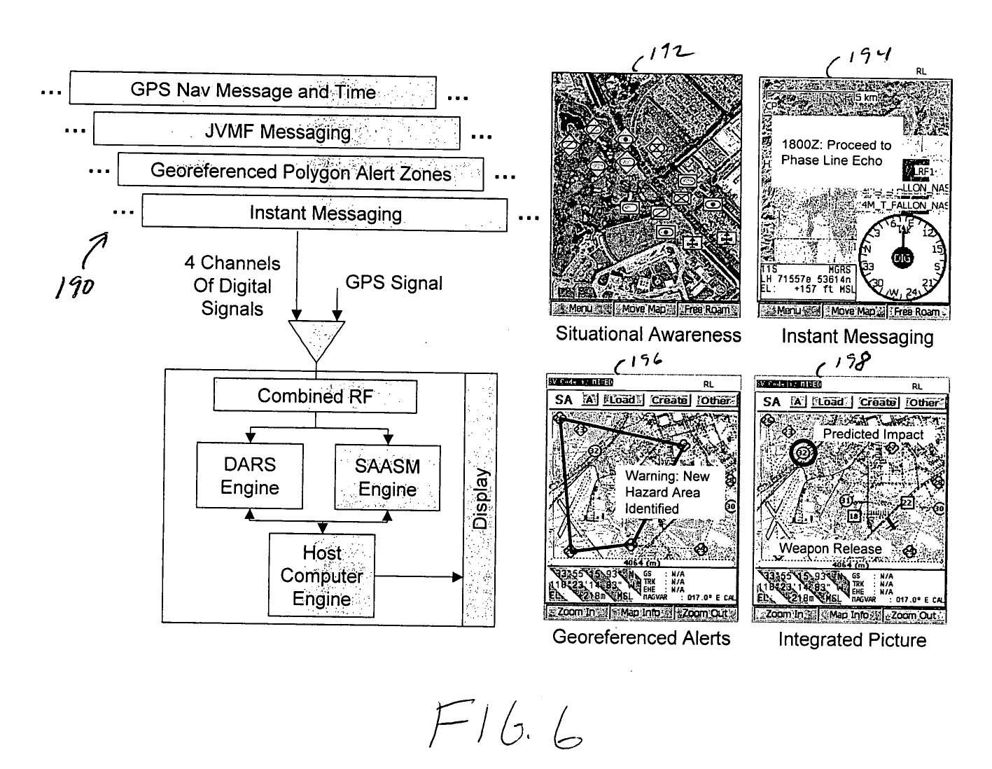

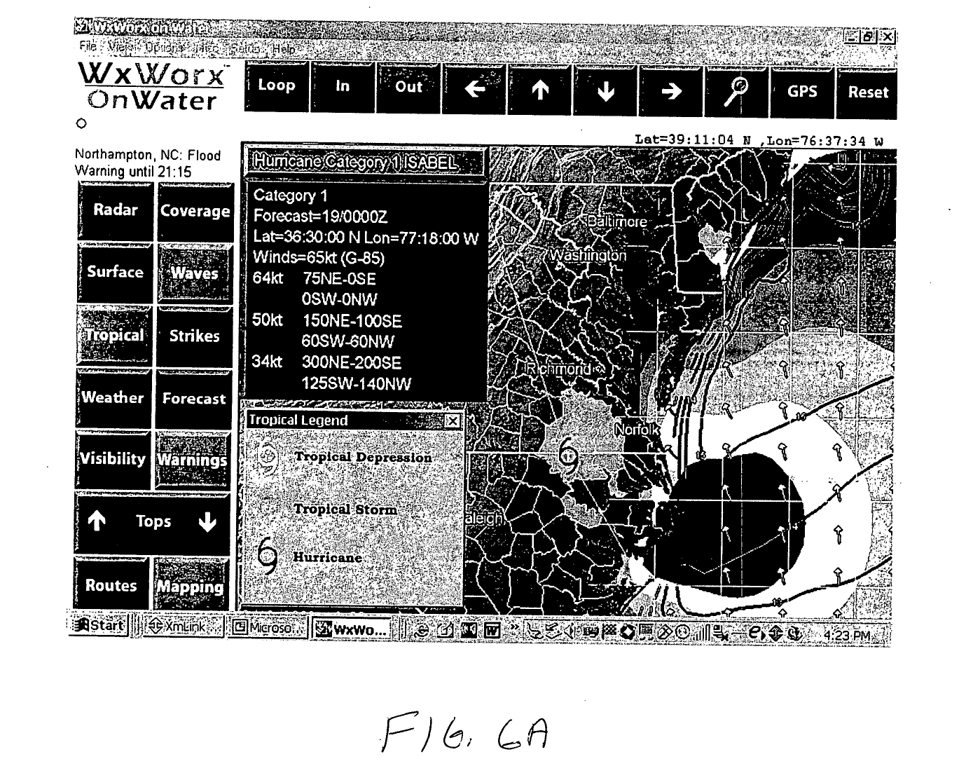

FIG. 6 is a pictorial and block diagram of a compact mobile terminal for obtaining and displaying information according to the invention. In this example, four channels of digital signals are provided to include an instant messaging data signal, a georeferenced data signal, a JVMF message data signal and a GPS Nav message data signal which are then provided to a display when selected. As shown in window 192, situational awareness data can be provided, as shown in window 194, instant messaging data can be provided, as shown in window 196, georeferenced alerts data can be provided, and as shown in window 198, an integrated picture can be provided,

FIG. 6A is a pictorial diagram showing satellite weather information within a display of a mobile terminal according to the invention.

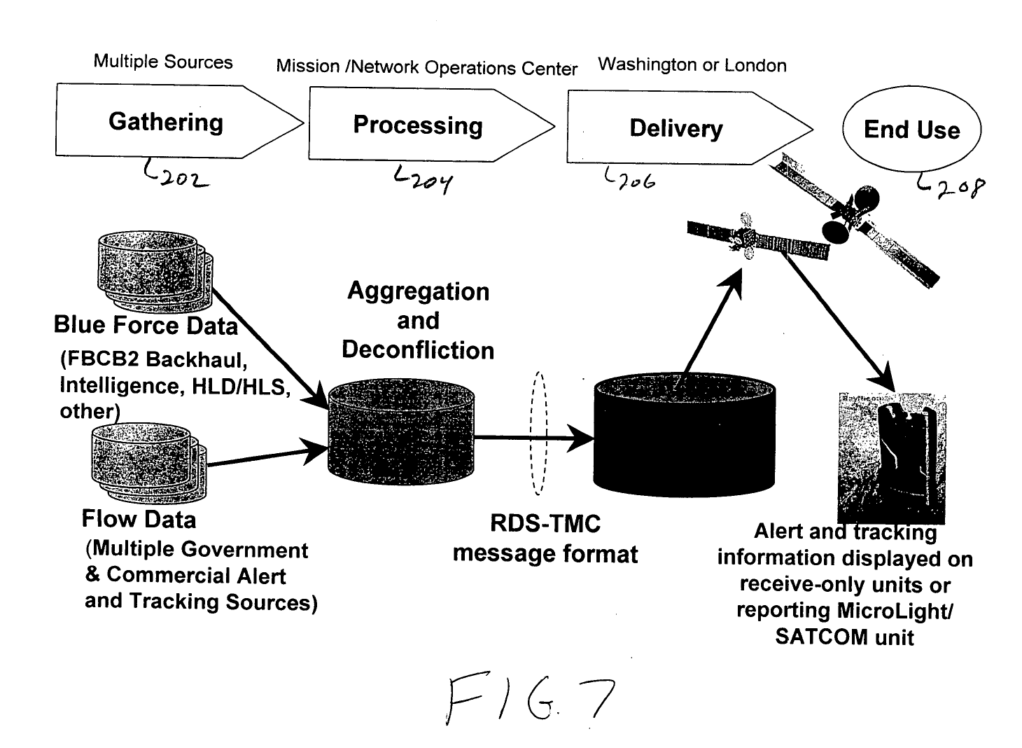

Referring now to FIG. 7, a pictorial and block diagram of a real-time alerting and data delivery process according to the invention is shown. As shown in the gathering step 202, multiple sources are gathering information and providing the information to a network operation center. The network operation center may either be located in the local network or outside the local network at a higher level network. As shown in processing step 204, the information is aggregated and deconflicted. Collaborating the information and segregating and eliminating the misinformation is accomplished at this step and the information is delivered to the intended recipient. Depending on the configuration of the system and the type of information, the information may be forwarded to a higher echelon for further processing with other information or as shown in delivery step 206, the information may be delivered to the end users as shown in step 208 to be displayed as needed.

It should be appreciated that FIG. 7 shows a flowchart corresponding to the contemplated technique which would be implemented in situational awareness system 100 (FIG. 1A) and the elements represent computer software instructions, or groups of instructions which affect the execution of the computer software instructions represented by the processing blocks. The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

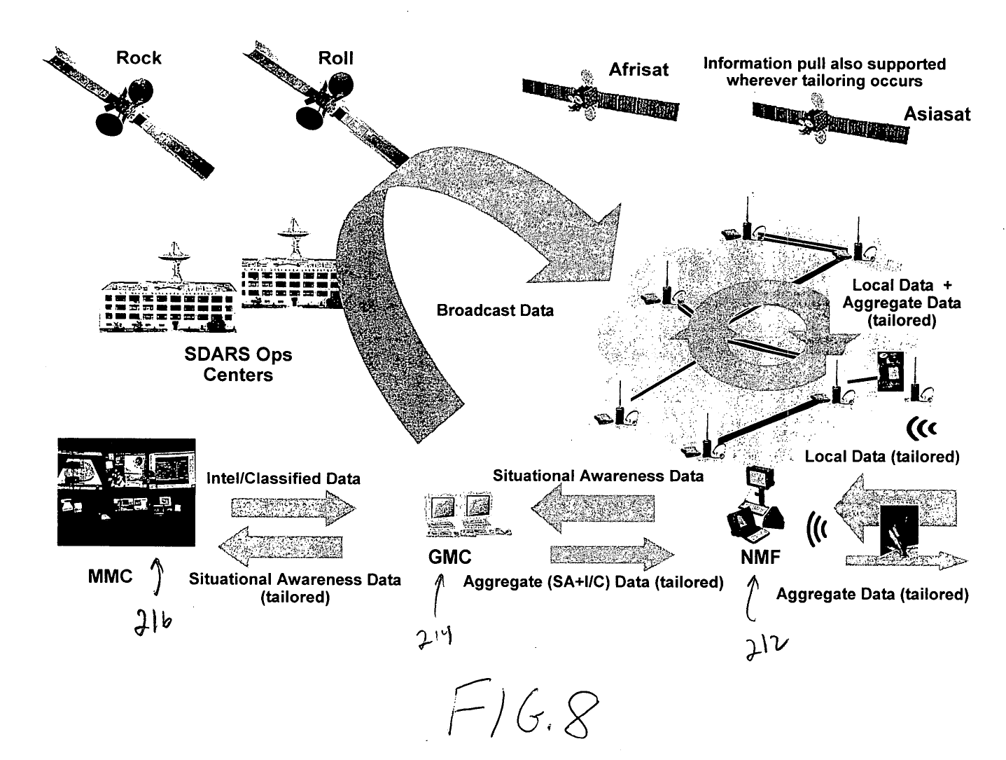

Referring now to FIG. 8, another detailed pictorial and block diagram of information flow process according to the invention is shown. Local data is gathered and provided to the node management facility (NMF) 212. The NMF 212 gathers and deconflicts the information to create situational data and forwards the data to the global management center (GMC) 214. In a similar manner, command and control information is provided from the MMC 216 to the GMC 214. The GMC 214 tailors the situational awareness data and provides such data to the users including the MMC 216, the NMF 212 and individual users (not shown). Each of the agencies requiring the data are included in the information pull process as well as the information push process.

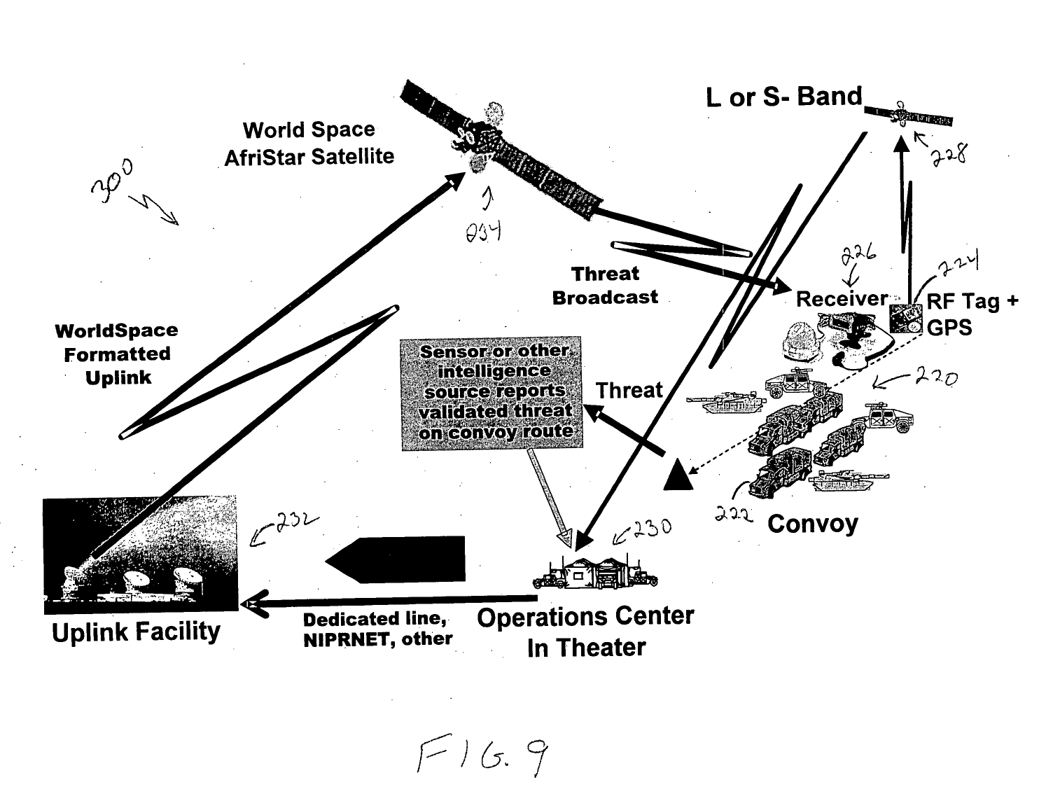

Referring now to FIG. 9, a pictorial diagram of situational awareness system 300 for a convoy 220 in route with a real-time alerting and data delivery process according to the invention is shown. Located within a vehicle 222 are an RF Tag 224 and a receiver 226. The RF Tag 224 includes an integrated GPS receiver with a satellite transceiver capable of communicating using L-band or S-band with a satellite 228. Thus, the RF Tag 224 will transmit a signal to the satellite 228 which will transmit a signal to provide information a network operation center 230. The network operation center 230 may either be located in theater or outside the theater. At the operation center 230, the information is aggregated and de-conflicted and timely information regarding the convoy including instructions to the convoy 222 can be distributed to intended recipients. To distribute the information, the operation center 230 is connected to an uplink facility 232 where a signal is communicated with a satellite 234, here a World Space AfriStar Satellite, and broadcast to the intended recipients including receiver 226. Depending on the configuration of the system and the type of information, the information may be also forwarded to a higher echelon for further processing with other information before the information is delivered to end users including receiver 226. With such an arrangement, the identity and location of a vehicle 222 can be communicated to an operation center 230 and aggregating such information with other information, information regarding the vehicle 222 and convoy 220 can be communicated to recipients having a need to know.

Having described various embodiments of the invention, it should now be appreciated that a situational awareness system according to the present invention includes a first local network having a plurality of digital communication devices, each device capable of gathering information pertinent to an area in proximity of the device and providing information to a control station capable of collaborating the information and provide such information to the devices on the local network. The system further includes a first regional network having a plurality of local networks, including the first local network, within an area of responsibility, the first regional network having a regional control station capable of collaborating information from the local control station and alternatively, from the digital communication devices and provide said information to devices on the local network and a central network having a plurality of regional networks including the first regional network, the central network having a central control station capable of collaborating information from the regional control stations and provide the information to devices on a local network. By equipping users, whether individuals, platforms or assets, with handheld equipment that develops position location information about them while also serving as a data communications network for them, information can be gathered without user intervention. Besides sharing local situational data among local network members, each network also provides a tailored version of this situational data to the control center. The control center develops a larger joint battlespace situational awareness (JBFSA) picture based on inputs from all networks in operation, exchanges data with the MMC and FBCB2 BFT, and develops content streams (data and/or audio) for broadcast over DARS. These content streams admit receipt by all equipped users thus bringing situational awareness to levels never before reached in a format compatible with user tasking.

Such an arrangement provides worldwide dissemination of JBFSA information by narrowcasting both data and audio using digital audio radio satellites (DARS) currently on-orbit to all levels including aircraft, tanks, artillery but also including individual warfighters or first responders. Fusion of GPS and other techniques for geolocation and tracking to include forces down to the level of individual warfighters or first responders and assets down to individual items is provided. Availability of position location and voice information in environments such as urban areas, building interiors, and caves where line-of-sight systems including satellite communications and GPS typically fail can be accomplished. The GMC fuses MCC JBFSA data with its own data to form situational awareness content for shipment to the DARS subsystem for broadcast and, in some cases, for directed return through the GIG to specific users.

As described above, it should now be appreciated that Mobile Enhanced Situational Awareness (MESA) is a key improvement over existing systems wherein any end user may receive needed information from the transmission of content over Satellite Digital Audio Radio Services to commercial multi-chip module receivers capable of receiving signals from XM Radio or Worldspace. MESA provides broadcast services at a rate roughly 10 times the speed and throughput of standard narrowband satellite communication services. User devices are small and simple, and the global networking functions allow for unique addressing of receivers to mobile battery-powered users on the move or not. MESA takes advantage of the commercial receiver development and with the infrastructure in place already, the MESA network can be implemented immediately. Text messages, audio, satellite photos, geographic overlays, streaming data and video may all be communicated over the MESA system.

Multiple return links allow for either full rate communications or simple spread-spectrum auto identification techniques in either terrestrial or space based capability to be correlated and rebroadcast as overlay to the MESA network. Developments in mobile satellite systems and RFID technologies are easily integrated within MESA and offer any user a “see and be seen” system. The MESA capabilities do not challenge the integrity of existing systems, but augment them. This system offers a universal serial XML stream for the transmission and reception of content over most of the planet's land masses and littoral waterways.

The MESA format can also be broadcast as a data file over the internet, or over high capacity broadband on DIRECTV. This allows for MESA content to be implemented at more permanent facilities and command centers, or for pervasive dissemination of alert information to the population at large. It should be appreciated that the MESA network can be implemented across the 810 terrestrial repeaters in the 70 largest urban areas in the United States. This terrestrial repeater architecture offers multiple Homeland Security dual and tri-use applications for not only MESA dissemination, but integration of 3 G and 4 G wireless service integration and the installation of sensor and “sniffer” systems for biochemical warning, weather, and pollutants analysis. The implementation of the use of playlists for data management and control allow MESA to effectively orchestrate a wide range of alert and situational awareness architectures.

It should be appreciated that MESA can be integrated with the ACU-1000 interoperability system sold by Raytheon Company's subsidiary, JPS Communications, Inc. The MESA receiver and protocol are used as the alert mechanism to an obligated receiver. This receiver is the input for the dissemination of alert and data messages to cell-phones, satcom, military and civil radios, blackberries, terrestrial VHF and UHF radios, IP phones and pagers across a large urban area.

The combined current and future footprints of XM and Worldspace offer enormous MESA coverage potential for the planet. It should be noted that this footprint extends to the third dimension so support to aircraft aloft, UAVs, robotic assets, surface and subsurface platforms can attain various levels of support from the system. Additionally since the broadcast satellites are at 22,300 miles above the earth, the MESA architecture and system can selectively provide support to NASA and ESA Human Flight Missions and the International Space Station.

It has been shown that MESA can be used as an effective common operational picture and situational awareness tool for the dissemination of intelligence and for consequence management command and control to mobile assets that are limited to local knowledge. It may be used to provide an alert warning template of a potential strike area and the associated situational awareness overlay generated at the receiver end indicating the zone of severity to this alert. Such applications will be of value for traffic monitoring, emergency alerts, first responder services, warnings to general aviation aloft, severe weather and hurricane warnings, and of course the issues associated with WMD, Natural Disasters and terrorist attacks. MESA includes the ability to broadcast tailored messages in any alert scenario. In one example, an aircraft has been hijacked. Critical assets are scrambled or placed on notice to deal with consequences, and threat levels for a variety of locations in the Federal Threat Level program can be provided to the critical assets. MESA also in a very effective means of delivering space products that already exist. It should be appreciated that one can implement PKI for unattended and attended assets and networks that include the security, management and control of up to 25 million unattended assets that may or may not be tied to a network or that may not be able to even have network access without this type of a network initiation feature. The system implements MESA for over-the-air-rekeying (OTAR) of devices and (OTAA) over-the-air-authentication of the asset in question. In one instant, in a convoy scenario, information is broadcast from space to cue a convoy commander to the absence or presence of intelligence tied to Improvised Explosive Devices (IEDs), preferred routes, or ad hoc mission changes based upon circumstance. The same architecture can apply to most any logistical or administrative operation requiring the dissemination of Command and Control information to its fleet. The latter with a return link via satcom or RFID results in an integrated two-way Friendly Force Tracking Asset, a combat survivor evader locator system, a targeting system, and a Situational Awareness Tool tied to Public Safety and Security (e.g. US Coast Guard response to a capsized yacht. First Responder incident management and asset tracking). The system can be integrated with underwater buoy sensor systems that are deployed on the ocean floor. These are “information mines”. Through vibration, acoustical pressure, or altitude change, the buoys fill with hydrogen gas and surface. At the time of surface, the buoys report their latitude, longitude and ID, and the sensor severity is reported as a brevity code. The information mine picture is collected to evaluate localization of a Tsunami or other event, run through a predictive model, and reported over MESA as an alert to the prospective affected areas.

Having described the preferred embodiments of the invention, it will now become apparent to one of ordinary skill in the art that other embodiments incorporating their concepts may be used. It is felt therefore that these embodiments should not be limited to disclosed embodiments but rather should be limited only by the spirit and scope of the appended claims.

What is claimed is:

1. A situational awareness system comprising:
a first local network having a plurality of digital communication devices, each device capable of gathering information pertinent to an area in proximity of the devise and providing information to a local control station capable of collaborating the information and provide such information to the devices on the local network;
a first regional network having a plurality of local networks, including the first local network, within an area of responsibility, the first regional network having a regional control station capable of collaborating information from the local control station and provide said information to devices on the local network; and
a central network having a plurality of regional networks including the first regional network, the central network having a central control station capable of collaborating information from the regional control stations and provide the information to devices on a local network.

2. The situational awareness system as recited in claim 1 wherein the local network is a digital audio radio satellite system having a plurality of mobile satellite transceivers capable of communication with each other through a satellite.

3. The situational awareness system as recited in claim 1 wherein the information includes global position system (GPS) location information of a digital communication device.

4. The situational awareness system as recited in claim 1 wherein the digital communication device is disposed within a moving vehicle.

5. The situation awareness system as recited in claim 4 wherein the moving vehicle is an aircraft.

6. The situation awareness system as recited in claim 4 wherein the moving vehicle is a tank.

7. The situation awareness system as recited in claim 1 wherein the information includes data, video, navigational and audio information.

8. The situation awareness system as recited in claim 1 wherein the local network is a terrestrial repeater network having a plurality of transceivers capable of communicating with each other using geographically dispersed repeaters.

9. The situation awareness system in claim 1 wherein all of the collaborated information is communicated to the regional control system.

10. The situation awareness system in claim 1 wherein selected portions of the collaborated information is communicated to the regional control system.

11. The situation awareness system in claim 1 wherein the regional networks are connected using one of the techniques including land lines, radio links and satellite links to provide regional collaborated data to the central control system.

12. The situation awareness system in claim 1 wherein the central control system broad casts the collaborated data to any communication device who has requested the collaborated data.

13. The situation awareness system in claim 1 herein the first local network includes a combination of a terrestrial repeater system and a digital audio radio satellite system.

14. A situational awareness mobile space broadcast system comprising:
a first local network having a plurality of digital communication devices, each device capable of receiving information pertinent to an area either by unit type, geographical location, hierarchy, or precedence in proximity of the devise and also provide such information to the devices on the local network;
a first regional mobile broadcast network having a plurality of local networks with entertainment broadcast services, including the first local network, within an area of responsibility, the first regional network having a regional control station capable of collaborating information from the local control station and provide said information to devices on the local, regional, or global broadcast network; and
a central network having a plurality of regional networks including the first regional network, the central network having a central control station capable of collaborating information from the regional control stations and provide the information to devices on a local network or in local, regional, or global satellite mobile broadcast over entertainment channels.

15. The situational awareness mobile space broadcast system as recited in claim 14 wherein the local network is a digital audio radio satellite system having a plurality of mobile satellite receivers, alternatively satellite receivers with local GPS, alternatively satellite receivers with local GPS location broadcast, alternatively satellite receivers with satcom or line-of-site radios capable of communication with each other through a satellite or other networks.

16. The situational awareness mobile space broadcast system as recited in claim 14 wherein the information includes global position system (GPS) location, timing, or reference information sent via a common reference hub as an GPS augmentation signal to subject entertainment receiver wherein said signal is reintroduced to standard GPS users.

17. The situational awareness mobile space broadcast system as recited in claim 14 wherein the digital communication device is disposed within a robot.

18. The situation awareness mobile space broadcast system as recited in claim 14 wherein the moving vehicle is an aircraft.

19. The situation awareness mobile space broadcast system as recited in claim 14 wherein the moving vehicle is a tank, alternatively a ship, or alternatively a submarine.

20. The situation awareness mobile space broadcast system as recited in claim 14 wherein the information includes data, video, navigational and audio information.

21. The situation awareness mobile space broadcast system as recited in claim 14 wherein the local network is a terrestrial repeater network having a plurality of transceivers capable of communicating with each other using geographically dispersed repeaters.

22. The situation awareness mobile space broadcast system in claim 14 wherein all of the collaborated information is communicated to the regional control and net management system.

23. The situation awareness mobile space broadcast system in claim 14 wherein selected portions of the collaborated information is communicated to the regional control and net management system.

24. The situation awareness mobile space broadcast system in claim 14 wherein the regional networks are connected using one of the techniques including land lines, radio links and satellite links to provide regional collaborated data to the central control system.

25. The situation awareness mobile space broadcast system in claim 14 wherein the central control system broad casts the collaborated data to any communication device who has requested the collaborated data or receives data in a scheduled broadcast.

26. The situation awareness mobile space broadcast system in claim 14 herein the first local network includes a combination of a terrestrial repeater system and a digital audio radio satellite system.

27. A situational awareness system comprising:
(a) a plurality of local communication devices capable of providing device dependent information to a regional information center, the regional information center capable of integrating and collaborating the device dependent information to provide global situational awareness information;
(b) a digital audio radio satellite system to commute the global situational awareness information to mobile transceivers; and
(c) a digital audio radio satellite system to commute the navigation augmentation signals to mobile transceivers utilized for improved GPS performance.
